(19) United States
(12) Patent Application Publication
(10) Pub. No.: US 2020/0399020 A1
(43) Pub. Date: Dec. 24, 2020

(54) DECORATIVE BOTTLE CONTAINER

(71) Applicants: Brian House, Ellington, CT (US); Matthew House, Ellington, CT (US)

(72) Inventors: Brian House, Ellington, CT (US); Matthew House, Ellington, CT (US)

(21) Appl. No.: 16/996,331

(22) Filed: Aug. 18, 2020

Related U.S. Application Data
(63) Continuation of application No. 14/143,774, filed on Dec. 30, 2013.
Application No. 14/143,774 is a continuation-in-part of application No. 13/772,880, filed on Feb. 21, 2013, now abandoned.

(51) Int. Cl. B65D 23/00; F21V 35/00

(52) U.S. Cl. CPC B65D 23/00; F21W 2121/00; F21V 35/00

(57) ABSTRACT

A container is provided including a generally hollow cylindrical base having a cavity configured to retain one or more items. A lid is removably coupled to the base. The lid has a first portion adjacent a first end and a second portion near a second end. The first portion of the lid is generally complementary to the base. An insert is coupled to an interior surface of the first portion of the lid. The insert extends generally beyond a first end of the lid such that when the lid is attached to the base, a section of the insert including a raised portion is received within the cavity of the base. The raised portion of the insert is configured to generate a sealing pressure fit when positioned against an interior surface of the cavity.

### CROSS REFERENCE TO RELATED APPLICATIONS

This application is a continuation of U.S. application Ser. No. 14/143,774, filed Dec. 30, 2013, which is a continuation in part of U.S. application Ser. No. 13/772,880, filed on Feb. 21, 2013 the contents of which are incorporated herein by reference.

### BACKGROUND OF THE INVENTION

Exemplary embodiments of this invention generally relate to containers and, more particularly, to a decorative bottle container configured to store one or more items.

Candles are well known and are generally used as a light source during emergency situations, such as when electrical power is lost for example. In addition, candles are also used for decorative purposes. Candles are generally available in a variety of scents and colors and may add ambiance to a room or other setting while providing a scented aroma during the burning of the candle.

Candles generally include a wick arranged at a center point of a wax body. Some candles, such as taper candles for example, are intended for use with a separate candle holder. Other candles have decorative shapes, or may be housed in a decorative container. Some candles are arranged within a bottom portion of a new or recycled glass bottle, such as a beer bottle or wine bottle for example. However, these candles generally do not have an aesthetically pleasing appearance when the candle is not in use.

### BRIEF DESCRIPTION OF THE INVENTION

According to one embodiment of the invention, a container is provided including a generally hollow cylindrical base having a cavity configured to retain one or more items. A lid is removably coupled to the base. The lid has a first portion adjacent a first end and a second portion near a second end. The first portion of the lid is generally complementary to the base. An insert is coupled to an interior surface of the first portion of the lid. The insert extends generally beyond a first end of the lid such that when the lid is attached to the base, a section of the insert is received within the cavity of the base. The section includes an undercut and a raised portion configured to function as a sealing mechanism to generate a sealing pressure fit when positioned against an interior surface of the cavity.

According to an alternate embodiment of the invention, an insert configured to selectively couple a first component and a second component is provided including a cylindrical body having an outer surface. A section of the outer surface includes an undercut and an adjacent raised portion configured to generate a sealing pressure fit when the raised portion is arranged against an interior surface of a cavity of the first component.

According to yet another embodiment of the invention, a canister is provided including a generally hollow cylindrical body having an internal compartment configured to store one or more items. A top coupled to the cylindrical body is movable between a closed position and an open position to access the internal compartment.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a front view of a container according to an embodiment of the invention;

FIG. 2 is a side view of a separated base and lid of a container according to an embodiment of the invention;

FIG. 3 is a partial cross-sectional view of a lid of a container according to an embodiment of the invention;

FIG. 4 is a top view of an insert configured to couple the lid and base of the container according to an embodiment of the invention;

FIG. 4A is a cross-sectional view of the insert of FIG. 4 according to an embodiment of the invention;

FIG. 5 is a cross-sectional view of an assembled base and lid of a container according to an embodiment of the invention;

FIG. 6 is a front view of a canister configured to be arranged within the lid according to an embodiment of the invention;

FIG. 6A is a perspective view of the canister of FIG. 6 according to an embodiment of the invention;

FIG. 6B is a top view of the top of the canister of FIG. 6 according to an embodiment of the invention;

FIG. 7 is a partial cross-sectional view of a lid of a container according to another embodiment of the invention;

FIG. 8 is a cross-sectional view of a base of a container according to an embodiment of the invention;

FIG. 9 is a top view of a base of the container according to an embodiment of the invention;

FIG. 10 is a cross-sectional view of a base of the container according to another embodiment of the invention; and

FIG. 11 is a top view of a divider arranged within the base of the container according to an embodiment of the invention.

The detailed description explains embodiments of the invention, together with advantages and features, by way of example with reference to the drawings.

### DETAILED DESCRIPTION OF THE INVENTION

Referring now to the FIGS., a container 20 according to various embodiments of the invention is illustrated. The container 20 includes a housing 22 having a separable and complementary base 24 and lid 26. The housing 22 may be formed from a glass or other material. In one embodiment, the base 24 of the housing 22 includes a generally hollow elongated cylinder having a closed first end 28 and an open second end 30. The lid 26 is generally non-uniform in shape over its length such that the lid 26 has a first portion 32 adjacent a first end 34 and a distinct second portion 36 adjacent a second, opposite end 38. In one embodiment, the first portion 32 of the lid 26 has a generally semi-spherical shape and the second portion 36 has a generally narrow cylindrical shape. The diameter of the lid 26 near the first end 34 may be substantially larger than the diameter of the lid 26 taken near the second end 38. The diameter of the lid 26 at the first end 34 is generally equal to the diameter of the second, open end 30 of the base 24. In one embodiment, the housing 22 of the container 20 is configured to appear as a seamless, unaltered bottle when the lid 26 is positioned adjacent the base 24. Exemplary bottles that may be used to form the container 20 include, but are not limited to, wine, champagne, beer, liquor, and water bottles for example.

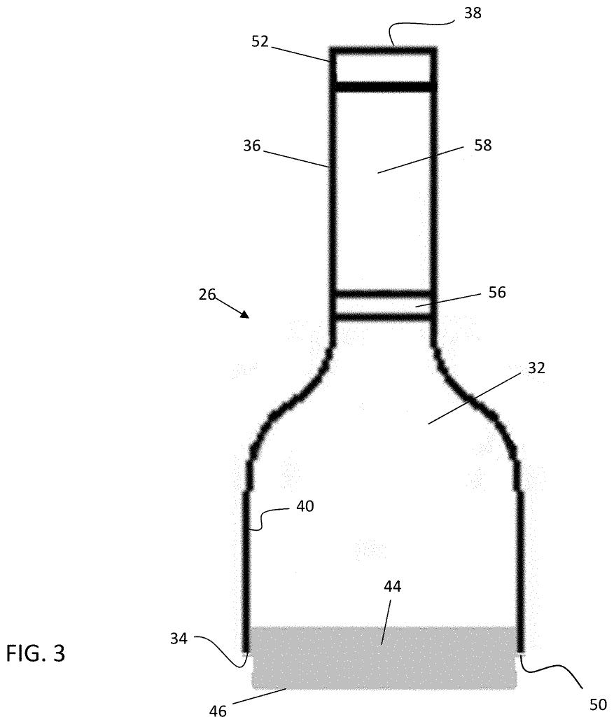

Referring now to the non-limiting embodiment illustrated in FIG. 3, a generally cylindrical insert 44 may be mounted about the circumference of an interior surface 40 of the lid 26, such as with an adhesive for example. In one embodiment, the insert 44 may be formed from a wood veneer. Alternatively, the insert 44 is generally formed from a deformable, elastic material including, but not limited to, plastic, silicone, rubber or a combination thereof for example. In one embodiment, the insert 44 is fabricated from a durable plastic material, such as polypropylene for example, formed using an injection molding process. The insert 44 may be generally clear or may be dyed a color complementary to the lid 26 to minimize the visibility of the insert 44 within the lid 26. An end 46 of the insert 44 extends beyond the first end 34 of the lid 26.

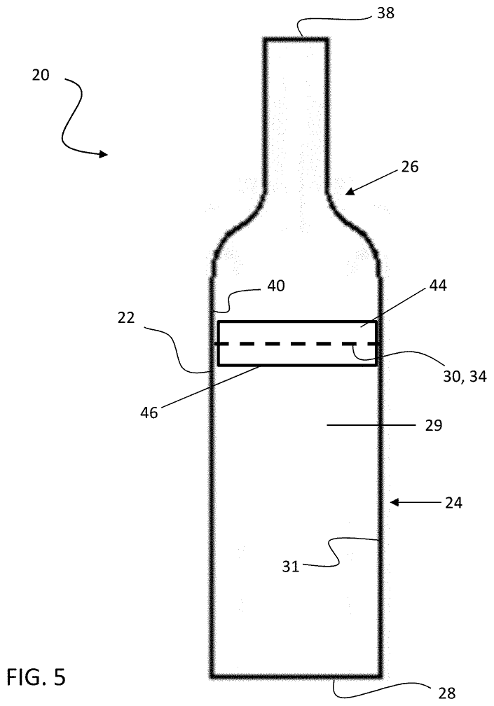

As shown in FIG. 5, when the lid 26 is positioned adjacent the second end 30 (FIG. 2) of the base 24, the end 46 of the insert 44 is received within the hollow cavity 29 of the base 24. A portion of the insert 44 adjacent end 46 may be generally clear or may be dyed a color complementary to the base 24 to minimize visibility of the insert 44 within the base 24 when the lid 26 and base 24 are connected. The insert 44 is configured to contact an interior surface 31 of the base 24 and vertically align the lid 26 relative to the base 24 (FIG. 5). In the non-limiting embodiment illustrated in FIG. 3, at least one protrusion 50, such as a divider for example, extends outwardly about the circumference of the insert 44.

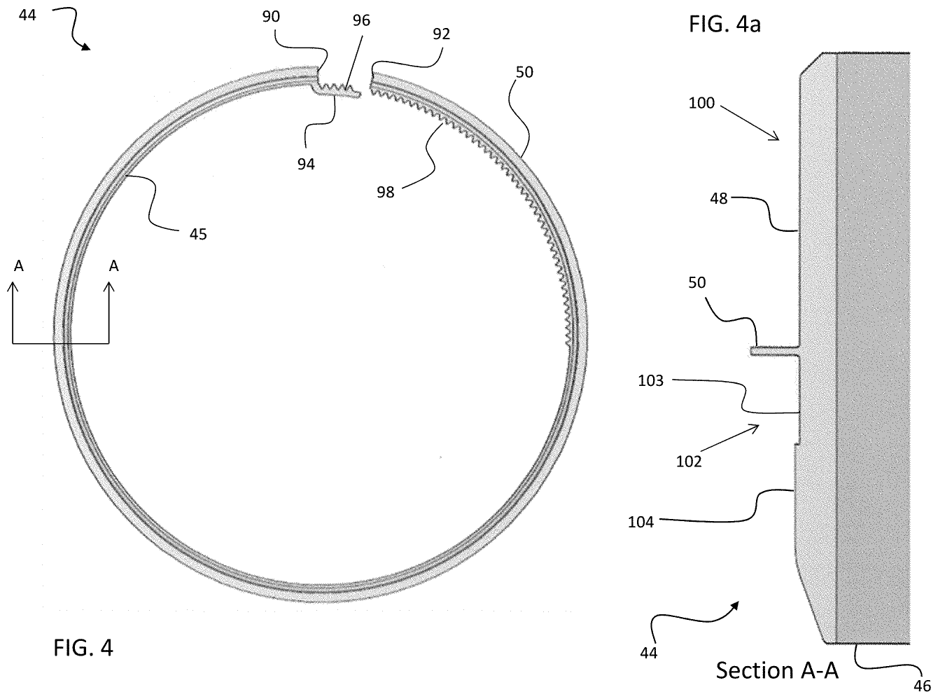

Referring now to the non-limiting embodiment illustrated in FIGS. 4 and 4a, the insert 44 may include an adjacent first edge 90 and second edge 92 configured to connect with one another. In the illustrated, non-limiting embodiment, a tab 94 extends from the interior surface 45 of the insert 44, adjacent the first edge 90, towards the second edge 92 and includes a plurality of outward facing teeth 96. Similarly, a portion of the interior surface 45 adjacent the second edge 92 includes a plurality of inward facing teeth 98 complementary to the outward facing teeth 96 of the tab 94. The first edge 90 and the second edge 92 of the insert 44 are arranged in contact with one another such that the meshed inward facing teeth 98 and outward facing teeth 96 are bonded, such as with an adhesive or ultrasound staking process for example Although the use of complementary teeth 96, 98 is described herein, other locking mechanisms configured to couple the first edge 90 and the second edge 92 of the insert 44 are within the scope of the invention.

In one embodiment, the insert 44 may be adapted to fit within a lid 26 having a circumference within a given range. A portion of the insert 44 may be removed from the second end 92 such that the insert 44 has a circumference complementary to the lid 26 when the outward facing teeth 96 of the tab 94 and the inward facing teeth 98 of the interior surface 45 are arranged in a meshing engagement.

As illustrated by the cross-section taken along A-A of FIG. 4, shown in FIG. 4a, the insert 44 may include a single protrusion 50 extending from a central portion of the outer surface 48 of the insert 44. The single protrusion 50 divides the outer surface 48 of the insert 44 into an upper section 100, configured to couple to the interior surface 40 of the lid 26, and a lower section 102 configured to contact the interior surface 31 of the base 24 when the lid 26 and base 24 are joined. To install the insert 44, adhesive is applied to the surface 48 of the upper section 100 of the insert 44. The insert is then inserted into the open end 34 of the lid 26 until the protrusion 50 generally abuts end 34. When the lid 26 is installed onto the base 24 of the container 20, the protrusion 50 is positioned generally between the second end 30 of the base 24 and the first end 34 of the lid 26 to prevent direct contact there between when attaching the lid 26 to the base 24.

The lower section 102 of the insert 44 functions as a sealing mechanism when the end 46 of the insert 44 is inserted into the base 24. The lower section 102 includes an undercut 103 positioned adjacent the protrusion 50, and a raised portion 104 having an increased thickness adjacent the second end 46. Together the undercut 103 and raised portion 104 generate a sealing pressure fit when inserted into the open end 30 of the base 24. The sealing pressure fit prevents slippage of the base 24 relative to the lid 26, such as when only the second end 38 of the lid 26 of the container 20 is supported.

In addition, the end 46 of the insert 44 may be tapered to ease the installation of the insert 44 within the open end 30 of the cavity 29 of the base 24. In one embodiment, the base 24 and either the lid 26 or insert 44 include markings to indicate to an operator the orientation of the lid 26 relative to the base 24 to ensure a proper fit when installing the lid 26 on the base 24.

With reference again to FIG. 2, a removable cover 52 is generally arranged adjacent the second end 38 of the lid 26. In one embodiment, the cover 52 is formed from a plastic or metallic sealing material and includes an exposed pull tab 54. A portion of the removable cover 52 may extend over the second end 38 and along the second portion 36 of the lid 26. The pull tab 54 is configured to separate from the remainder of the cover 52 to expose the second end 38 of the lid 26 when a force is applied thereto. In another embodiment, the cover 52 includes a screw top configured to threadably couple to the second end 38 of the lid 26 (FIG. 3). A partition 56, such as a disk fabricated from a cork, wood, or heat-resistant material for example, may be positioned near the junction of the first portion 32 and the second portion 36 of the lid 26 to form a compartment 58 within the second portion 36.

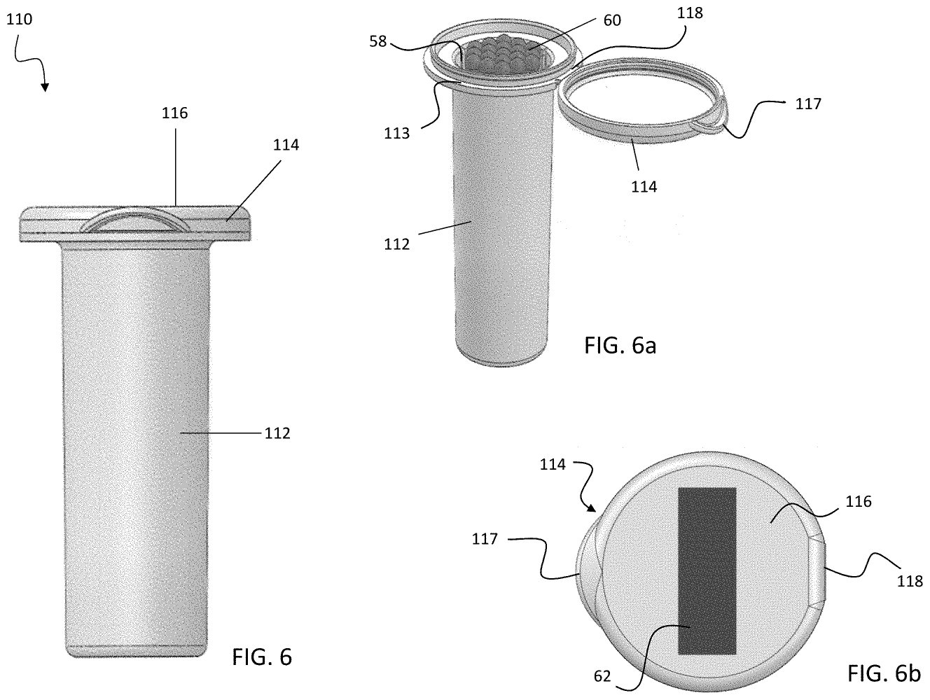

In another embodiment, illustrated in FIGS. 6, 6a, and 6b, a canister 110 may be inserted into the second end 38 and extend into the second portion 36 of the lid 26. The canister 110 may be permanently fixed within the second portion 36, such as with an adhesive for example, or may be removable from the second portion 36. In one embodiment, the canister 110 is fabricated from a durable plastic material, such as polypropylene for example, formed using an injection molding process. The canister 110 may be generally clear or may be dyed a color complementary to the lid 26 to minimize the visibility of the canister 110 within the lid 26. The canister 110 includes a generally hollow body 112 having an internal compartment 58. The body 112 may be generally complementary to the second portion 36 of the lid 26 and an end 113 of the body 112 may have an increased diameter configured to abut the second end 38 of the lid 26. In one embodiment, the canister 110 includes a top 114 removably or fixedly attached to the end 113 of the body 112, such as with a hinge 118 (FIG. 6a) for example. The top 114 is movable between an open position (FIG. 6a) and a closed position (FIG. 6) to access the compartment 58 of the body 112. In the illustrated, non-limiting embodiment, the top 114 includes a thumb tab 117 configured to assist an operator with moving the top 114 from a closed position to an open position. In embodiments where the cover 52 is a screw top, the canister 110 arranged within the lid 26 does not include a top 114.

As illustrated in FIGS. 6 and 6a, the internal compartment 58 of the canister 110 is configured to store a component related to the container 20, such as a note including a customizable message for example. In the illustrated, non-limiting embodiment, a plurality of matches 60 is arranged within the compartment 58. The matches 60 are generally contained within the compartment 58 until the cover 52 is removed and the second end 38 of the lid 26 is exposed. In embodiments where the cover 52 is a screw top, the compartment 58 may be accessed by unthreading the cover 52 from the lid 26. Alternatively, in embodiments where the compartment 58 is formed by a canister 110 having a top 114, the matches 60 are additionally contained within the compartment 58 until the top 114 of the canister 110 is moved to an open position.

In addition, as illustrated in FIG. 2, the container 20 may include a generally narrow strip of striking material 62 configured for use with one of the plurality of matches 60. The striking material 62 may be mounted to the exterior of the housing 22 of the container 20, such as wrapped at least partially about the circumference of the second portion 36 of the lid 26. Alternatively, the striking material 62 may be adhered to an outer surface 116 of the top 114 of the canister 110, as illustrated in FIG. 6b. In other non-limiting embodiments, the striking material 62 may be positioned in other areas, including, but not limited to the bottom 28 of the housing 22, or on the outside of the screw top cover 52 for example.

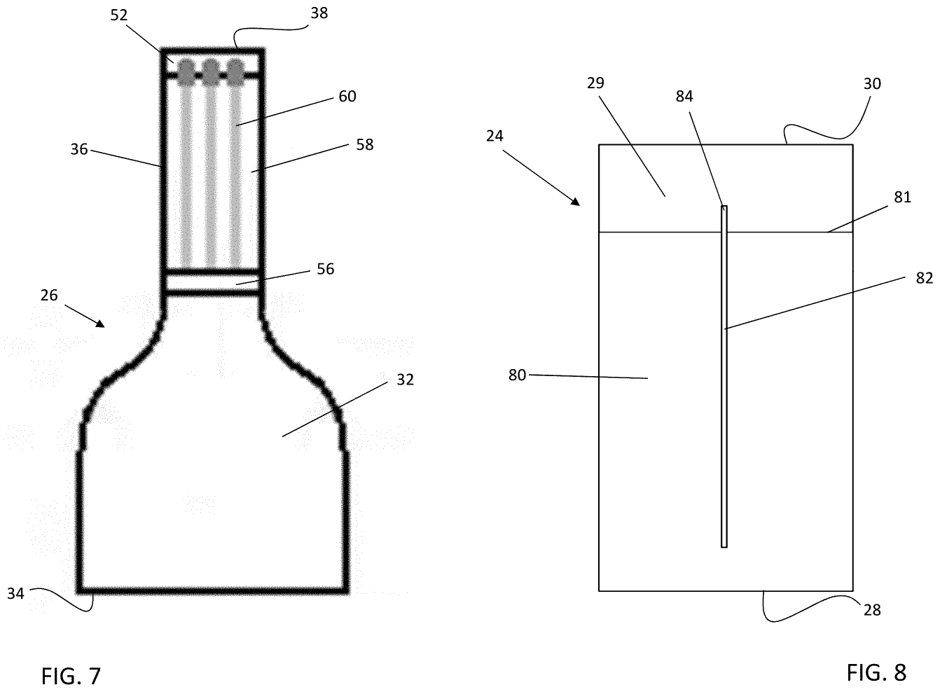

Referring now to FIGS. 7 and 8, a wax based candle 80 may be positioned within the cavity 29 of the base 24 such that an exposed end 84 of the candle wick 82 is arranged adjacent the open second end 30. The length of the wick 82 will vary with the candle 80 to prevent the base 24 from overheating. The candle 80 may have a diameter less than the diameter of the cavity 29 and may be removably located therein. Alternatively, the candle 80 may be formed integrally with the base 24, adjacent the first end 28, such as by pouring hot wax into the cavity 29 for example.

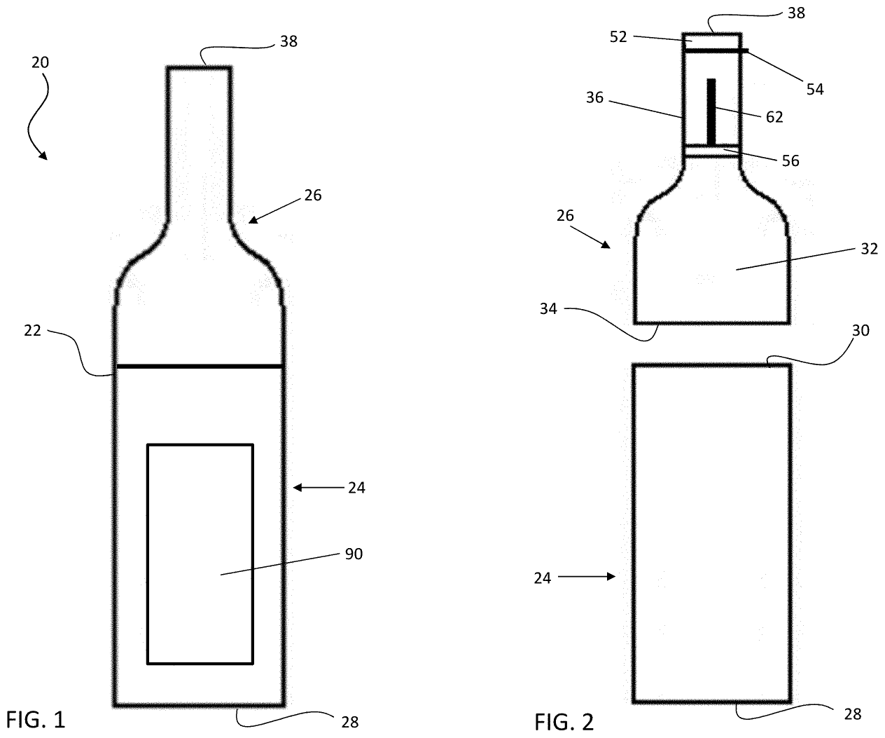

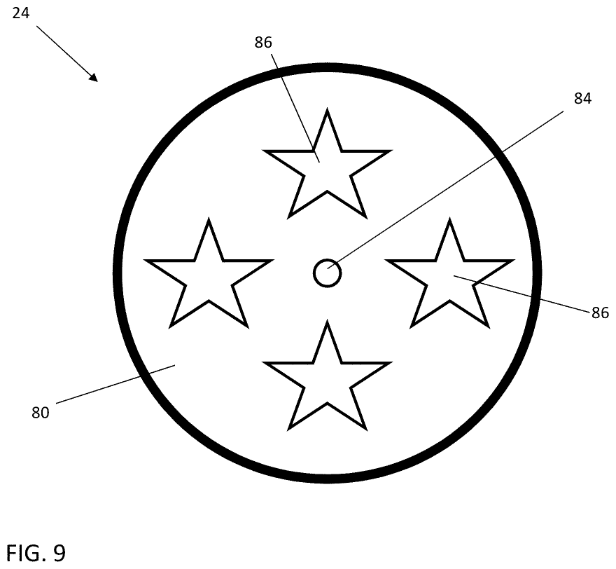

In one non-limiting embodiment shown in FIG. 9, one or more shapes 86 may be formed within the candle 80 and/or may extend from the surface 81 of the candle 80. Exemplary shapes include, but are not limited to, words, symbols, and holiday related shapes such as snowflakes, shamrocks, stars, hearts, flags, and trees for example. The candle 80 may be any color or any combination thereof. In one embodiment, the color and scent of the candle 80 are generally complementary to the container 20. For example, if the container 20 is formed from a new or recycled champagne bottle, the candle 80 may be generally beige colored with a champagne scent. Similarly, if the container 20 is formed from a new or recycled merlot bottle, the candle 80 may be generally red in color and have a wine, more particularly, a merlot scent. In addition, one or more labels 90, such as to indicate a brand and/or scent of the candle 20, or a warning label for example, may be arranged about the exterior of the housing 22 (FIG. 1).

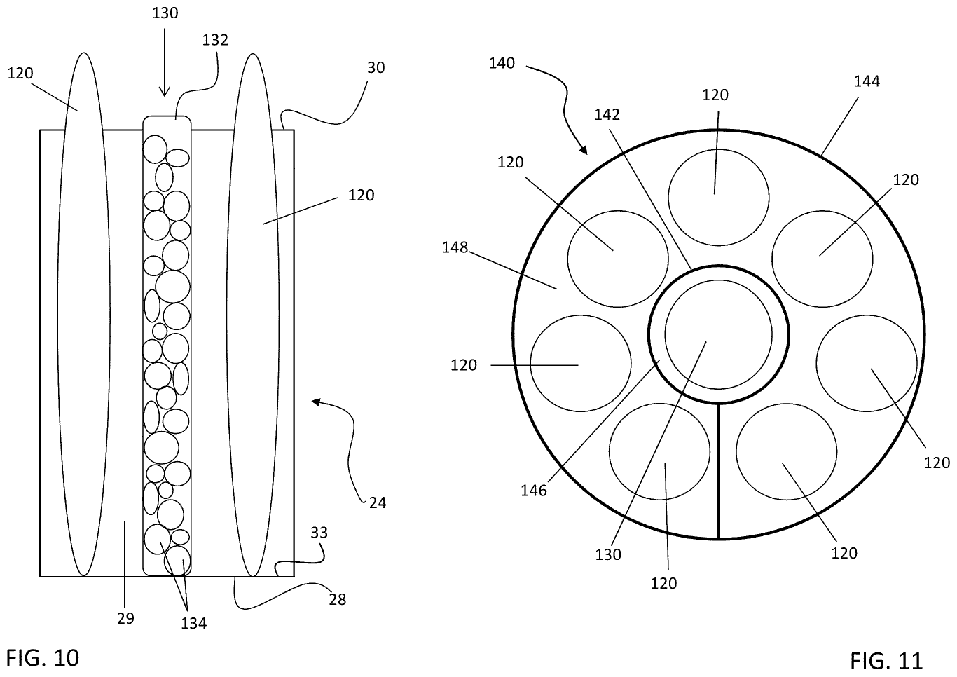

Although the container 20 has previously been illustrated and described as being configured to store a candle, other configurations where the container 20 is used to store a variety of other items are within the scope of the invention. Referring now to FIGS. 10 and 11, an alternative embodiment of the present invention is illustrated. Here the container 20 is adapted to hold one or more plurality of tobacco products 120 that require storage in a space having a constant humidity, such as cigars or cigarillos for example, in a manner similar to a humidor. Positioned within the cavity 29 of the base 24, generally centrally between a plurality of tobacco products 120, is a humidifier ampule 130 configured to regulate the humidity within the cavity 29. In one embodiment, the humidifier ampule 130 includes a hollow member 132 formed from a material permeable to water vapor but not liquid water. Arranged within the hollow member 132 is a plurality of crystals 134, such as DryMistat® crystals for example, configured to slowly release water via evaporation over time into the cavity 29.

As illustrated in the non-limiting embodiment of FIG. 11, a divider 140 configured to retain the humidifier ampule 130 generally within the center of a plurality of tobacco products 120 may be positioned within the cavity 29 of the base 24. The divider 140 includes a coupled inner member 142 and outer member 144 arranged generally concentrically to define a first opening 146 and a second opening 148. The first opening 146 is configured to receive and support the humidifier ampule 130 and the second opening 148 is configured to receive and support the plurality of tobacco products 120. The divider 140 may be configured to mount to an interior wall 31 of the cavity 29, such as with an adhesive for example, or may extend over at least a portion of the length of the cavity 29 such that the divider 140 is generally supported by an interior surface 33 of the closed end 28 of the base 24.

The container 20 may be formed by cutting a new or recycled bottle or housing 22 into a complementary base 24 and lid 26. Once the housing 22 is separated, one or more items, such as a candle 80 or tobacco product 120 for example, is positioned within the cavity 29 of the base 24, and an insert 44 is mounted adjacent the first end 34 of the lid 26. A canister 110 is inserted into the second end 38 of the lid 26. The striking material 62 may be mounted to the canister 110 or the housing 22 and/or the matches 60 may be inserted into the compartment 58 of the canister 110 before or after the canister 110 is installed into the lid 26. A cover 52 configured to seal the second end 38 is positioned on the lid 26 and one or more labels 90 are fastened to the exterior of the housing 22.

By forming the base 24 and lid 26 of a container 20 from a bottle, the container 20 is configured to appear as a seamless bottle, thereby improving the aesthetic appearance of the container 20 when the item(s) stored within the container 20, such as a candle or cigars for example, is not in use. In addition, the container 20 is configured to discreetly store a plurality of matches and striking material, configured for use with the item(s) contained within the base 24 of the container 20. In addition, because portions of the container 20 are customizable, such as the labels 90 or the appearance and scent of the candle 80 for example, the container 20 may be used in commercial applications. Exemplary commercial applications include, but are not limited to, use by vineyards and distilleries, use by retailers, use by businesses as marketing tools, or use as gifts at events such as a wedding for example.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A container, comprising
a generally hollow cylindrical base having a cavity configured to retain one or more items;
a lid, removably coupled to the base the lid having a first portion adjacent a first end and a second portion near a second end, the first portion being generally complementary to the base; and
an insert coupled to an interior surface of the first portion of the lid extends generally beyond a first end of the lid such that when the lid is attached to the base, a section of the insert is received within the cavity of the base, the section includes an undercut and a raised portion configured to function as a sealing mechanism to generate a sealing pressure fit when arranged in contact with an interior surface of the cavity of the base.

2. The container according to claim 1, wherein the base and the lid are generally formed from a bottle and when the lid and the base are attached, the container is configured to appear as an uncut bottle.

3. The container according to claim 1, wherein the insert includes an outwardly extending protrusion, the protrusion being positioned between the lid and the base when the lid is attached to the base.

4. The container according to claim 3, wherein the protrusion divides an exterior surface of the insert into an upper portion and a lower portion, and when the insert is coupled to the lid, the protrusion is configured to abut an end thereof.

5. The container according to claim 1, wherein the base and at least one of the lid and insert include complementary markings configured to indicate an orientation of the lid relative to the base when the lid is attached to the base.

6. The container according to claim 1, further comprising a canister including:
generally hollow cylindrical body having an internal compartment configured to store one or more items; and
a top coupled to the cylindrical body, the top being movable between a closed position and an open position to access the internal compartment.

7. The container according to claim 6, wherein the canister is positioned within the second portion of the lid.

8. The container according to claim 7, wherein at least one match is arranged within the internal compartment of the canister.

9. The container according to claim 8, wherein a striking material is mounted to a portion of the canister for use with the at least one match.

10. The container according to claim 1, wherein a candle is arranged within the cavity of the base.

11. The container according to claim 1, wherein at least one tobacco product and a humidifier ampule are arranged within the cavity of the base.

12. The container according to claim 11, further comprising a divider positioned within the cavity, the divider including a coupled inner member and outer member arranged generally concentrically to define a first opening and a second opening, the first opening being located near a center of the cavity.

13. The container according to claim 12, wherein the humidifier ampule is arranged within the first opening and at least one tobacco product is arranged within the second opening.

14. An insert configured to selectively couple a first component and a second component, comprising:
a cylindrical body having an outer surface, a section of the outer surface including an undercut and an adjacent raised portion configured to function as a sealing mechanism to generate a sealing pressure fit when the section is arranged against an interior surface of a cavity of the first component.

15. The insert according to claim 14, further comprising a protrusion extending outwardly from the outer surface, the protrusion being positioned between adjacent edges of the first component and the second component when the first component and the second component are coupled.

16. The insert according to claim 15, wherein the protrusion defines an upper section and a lower section of the outer surface, the upper section being coupled to a surface of the second component, and the lower section being configured to extend within the cavity of the first component and function as the sealing mechanism.

17. The insert according to claim 15, wherein when the insert is coupled to the second component, the protrusion is configured to abut an end thereof.

18. The insert according to claim 14, wherein an end of the cylindrical body near the raised portion is generally tapered.

19. The insert according to claim 14, wherein the cylindrical body includes a first edge and an adjacent second edge coupled in an interlocking arrangement.

20. The insert according to claim 19, wherein, a portion of the first edge includes a plurality of first teeth and a portion of the second edge includes a plurality of second teeth, the plurality of first teeth and the plurality of second teeth being generally complementary and arranged in meshing engagement.

21. The insert according to claim 19, wherein a circumference of the insert is adjustable by removing a portion of the second edge.

22. The insert according to claim 14, wherein the first component is a base of a container and the second component is a lid of a container, the lid and the base being generally complementary to one another.

23. A canister comprising:
a generally hollow cylindrical body having an internal compartment configured to store one or more items; and
a top coupled to the cylindrical body, the top being movable between a closed position and an open position to access the internal compartment, wherein the top includes a thumb tab configured to assist an operator with moving the top from a closed position to an open position.

24. The canister according to claim 23, wherein at least one match is positioned within the internal compartment, and a striking material is mounted to a portion of the canister.

25. The canister according to claim 23, wherein the generally hollow cylindrical body is generally complementary to a portion of a container such that the canister is configured to be mounted within the portion of the container.
